(19) United States
(12) Patent Application Publication
(10) Pub. No.: US 2016/0217539 A1
(43) Pub. Date: Jul. 28, 2016

(54) SYSTEM FOR RECORDING A LIFE STORY AND SHARING THE LIFE STORY AFTER DEATH

(71) Applicant: Aurora Casket Company, Inc., Aurora, IN (US)

(72) Inventors: Martin Strohofer, Aurora, IN (US); Michael Quinn, Aurora, IN (US)

(21) Appl. No.: 15/003,949

(22) Filed: Jan. 22, 2016

Related U.S. Application Data
(60) Provisional application No. 62/106,369, filed on Jan. 22, 2015.

(51) Int. Cl. G06Q 50/18; H04L 12/58; G06Q 50/00; H04L 29/08

(52) U.S. Cl. CPC G06Q 50/186; H04L 67/10; H04L 67/02; H04L 51/04; H04L 51/32; G06Q 50/01

(57) ABSTRACT

A system for recording a user's life is provided. The system includes a server and a database communicatively coupled to the server. The system causes the server to receive, over a computer network, content from a user; store, in the database, the content and an association between the content and the user; receive, over a computer network, an appointed guardian over the content; receive a notification of the death of the user; and grant the guardian administrative access to the content based at least in part on the notification.

### CROSS-REFERENCE TO RELATED APPLICATIONS

This application claims priority to and is a non-provisional of U.S. Provisional Patent Application Ser. No. 62/106,369 filed Jan. 22, 2015, and having the title “ONLINE COMMUNITY FOR RECORDING LIFE STORY,” which is herein incorporated in its entirety.

### BACKGROUND OF THE DISCLOSED EMBODIMENTS

The disclosed embodiments are related to a web-based system and, in particular, a web-based system for recording a life story.

Death is inevitable, yet the loss of a close friend or family member can lead to numerous complications and emotions. First, the deceased's loved ones must arrange for a funeral and burial plans. This can be difficult, particularly when the funeral intentions of the deceased are unknown. Most individuals pass away without a detailed funeral plan. This leaves the individual's loved ones having to determine the appropriate funeral and burial plans. This can be very difficult and stressful on loved ones, especially when the loved ones have differing opinions on the appropriate funeral and burial arrangements. Some individuals prepare funeral and burial plans well in advance of their death. However, the whereabouts of the plans are often unknown at the time that the individual passes away.

Second, many individuals worry about how they will be remembered or possibly missing the opportunity to leave a final message for loved ones. Often, an individual intends to leave lasting memories for their loved ones. Unfortunately, after an individual's death, the belongings of the individual are left disorganized. Despite some individual's attempts to leave behind photos, videos, and writings, these mementos along with other personal artifacts may be placed in boxes and stored away. Often these artifacts are sold at estate sales. As a result, the memories of the deceased quickly fade over time, such that most generations know very little about their family from previous generations. In time many people are forgotten, even by their own families.

A need remains for a centralized location to store funeral plans and lasting memories that may be cherished by loved ones long after an individual passes away.

### SUMMARY OF THE DISCLOSED EMBODIMENTS

The present embodiments provide an online social networking service where a user can record how they want to be remembered by their family, friends and loved ones, even after they have deceased. The user can record stories of their life, add pictures and video, describe how their end of life funeral event should be, and store private messages that are delivered to loved ones after they are deceased.

In at least one embodiment, a system for recording a user's life is provided. The system includes a server and a database communicatively coupled to the server. The system causes the server to receive, over a computer network, content from a user; store, in the database, the content and an association between the content and the user; receive, over a computer network, an appointed guardian over the content; receive a notification of the death of the user; and grant the guardian administrative access to the content based at least in part on the notification.

In at least one embodiment, a method for recording a user's life is provided. The method includes uploading content related to a user to a web page and appointing a guardian over the web page. A status indicator is selected when the user is deceased. The guardian is granted access to the web page after the status indicator is selected. The content of the web page is shared with selected individuals after the status indicator is selected.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a view of an exemplary webpage that forms a portion of a web platform formed in accordance with at least one embodiment.

FIG. 2 is a view of an exemplary webpage that forms a portion of a web platform formed in accordance with at least one embodiment.

FIG. 3 is a view of an exemplary webpage that forms a portion of a web platform formed in accordance with at least one embodiment.

FIG. 4 is a view of an exemplary webpage that forms a portion of a web platform formed in accordance with at least one embodiment.

FIG. 5 is a view of an exemplary webpage that forms a portion of a web platform formed in accordance with at least one embodiment.

FIG. 6 is a view of an exemplary webpage that forms a portion of a web platform formed in accordance with at least one embodiment.

FIG. 7 is a view of an exemplary webpage that forms a portion of a web platform formed in accordance with at least one embodiment.

FIG. 8 is a view of an exemplary webpage that forms a portion of a web platform formed in accordance with at least one embodiment.

FIG. 9 is a view of an exemplary webpage that forms a portion of a web platform formed in accordance with at least one embodiment.

FIG. 10 is a view of an exemplary webpage that forms a portion of a web platform formed in accordance with at least one embodiment.

FIG. 11 is a view of an exemplary webpage that forms a portion of a web platform formed in accordance with at least one embodiment.

FIG. 12 is a view of an exemplary webpage that forms a portion of a web platform formed in accordance with at least one embodiment.

FIG. 13 is a view of an exemplary webpage that forms a portion of a web platform formed in accordance with at least one embodiment.

FIG. 14 is a view of an exemplary webpage that forms a portion of a web platform formed in accordance with at least one embodiment.

FIG. 15 is a view of an exemplary webpage that forms a portion of a web platform formed in accordance with at least one embodiment.

FIG. 16 is a view of an exemplary webpage that forms a portion of a web platform formed in accordance with at least one embodiment.

FIG. 17 is a view of an exemplary webpage that forms a portion of a web platform formed in accordance with at least one embodiment.

FIG. 18 is a view of an exemplary webpage that forms a portion of a web platform formed in accordance with at least one embodiment.

FIG. 19 illustrates a method for recording a user's life in accordance with at least one embodiment.

FIG. 20 is an architecture diagram showing components of a system formed in accordance with at least one embodiment.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The present embodiments provide a web platform for an individual to upload a biography of themselves to the Internet. The platform is provided over the world wide web and is accessible via any Internet connection using a computer, mobile device, or the like. In at least one embodiment, the platform may be provided over a computer readable medium. The biography may include stories, videos, photos, and the like that are related to the user and uploaded to a personal website. Upon the user's death, the personal website becomes accessible to the public so that loved ones may remember the deceased individual. The website may become accessible to the general public or, alternatively, the website may only be accessible to loved ones who are provided with a password to access the personal website.

This detailed description is presented in terms of programs, data structures or procedures executed on a computer or network of computers. The software programs implemented by the system may be written in languages such as Ruby, PHP, Perl, ASP.net, Java, HTML, HTML5, Python, C++, C#, Javascript, and/or the Go programming language. It should be appreciated, of course, that one of skill in the art will appreciate that other languages may be used instead, or in combination with the foregoing and that web and/or mobile application frameworks may also be used, such as, for example, Ruby on Rails, Jo, Twitter bootstrap, and others. It should further be appreciated that the systems and methods disclosed herein may be embodied in software-as-a-service available over a computer network, such as, for example, the Internet.

During the user's life, the personal website remains password protected so that the content of the personal website is only visible by the user. The user has the option to appoint at least one guardian, who is provided access to the website after the user's death. In particular, upon the death of the user, a guardian logs onto the website and selects a status input to indicate that the user is deceased. The guardian is then permitted access to the website. Upon indicating that the user is deceased, some of the website content is automatically delivered to loved ones. Additional website content is made accessible to loved ones by permitting access to the website. For example, the guardian may forward an invitation to a selected list of loved ones providing a password to access the website.

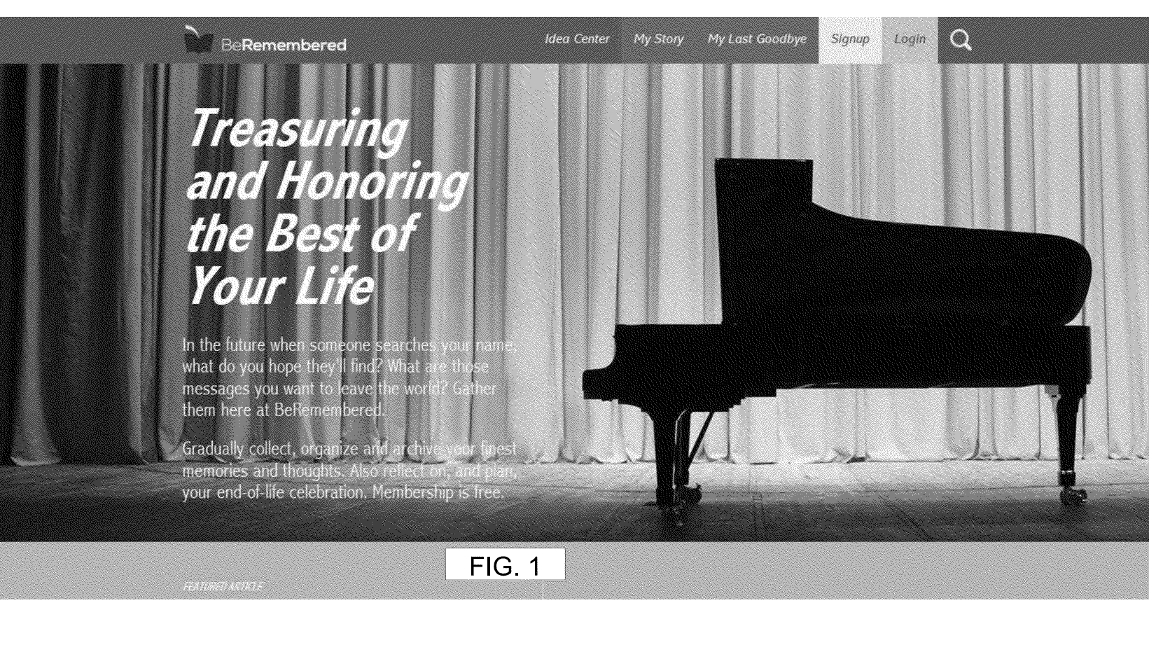

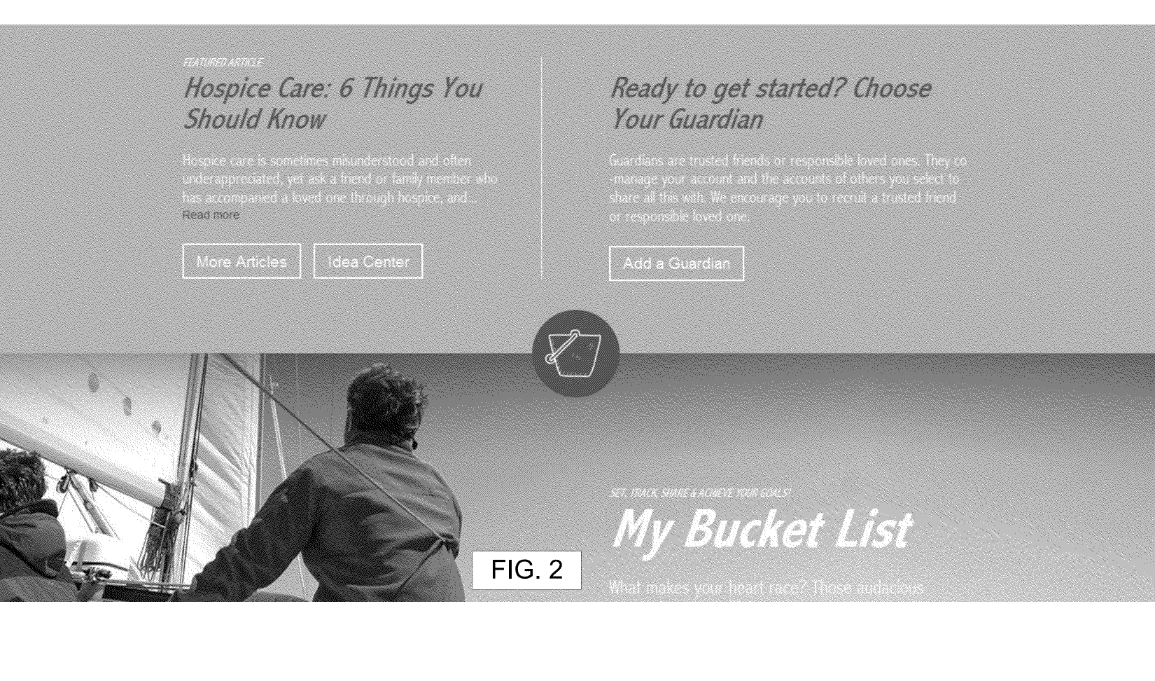

A sign up/log in page, as shown in FIGS. 1 and 2, allows the user to access the web platform. By click a sign up button, the user is transferred to a signup page that asks for identifying information about the user. It is on the sign up page that the user creates a secure user name and password. The user is then forwarded to an add guardian page that allows the user to add a guardian for the user's account. The guardian is the individual who is responsible for maintaining the account after the user is deceased. The added guardian is sent an email to verify that they wish to be named as a guardian on the user's account. After creating the account, the user is sent back to the sign up/log in page. By selecting the log in button, the user is prompted to enter their user name and password to access the user's personal website.

The sign up/log in page also features several informational sections, as shown in FIG. 2, describing the features of the web platform. On this page, an individual who is not certain about signing up can read more about the web platform and access articles and blogs related to planning for one's death.

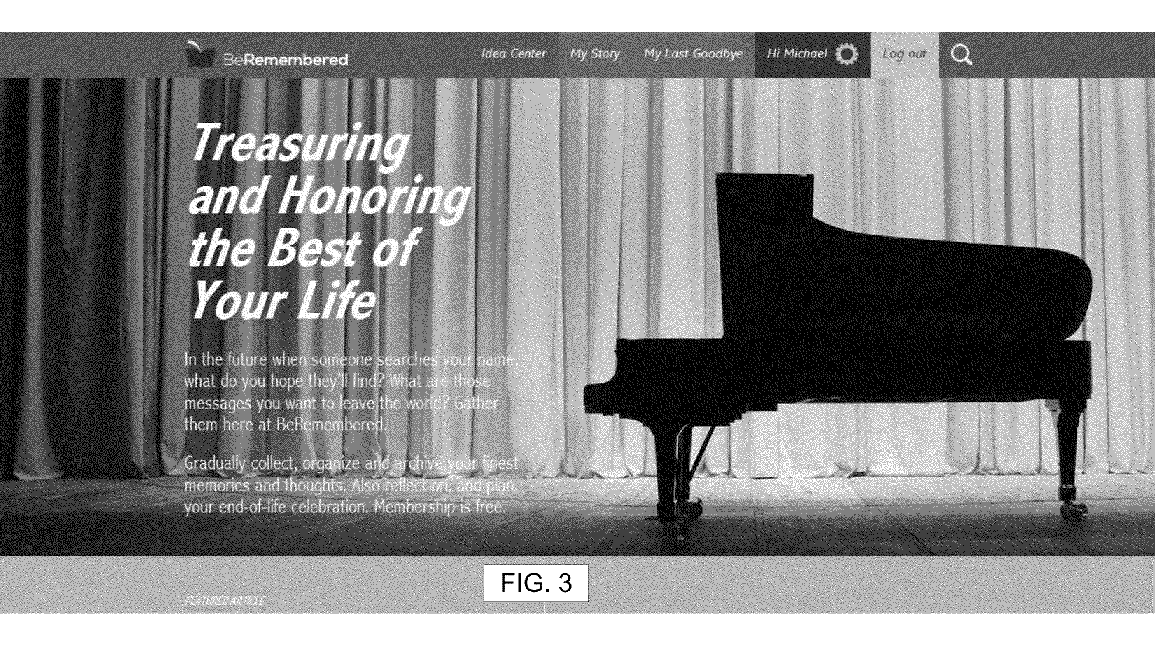

After logging in, the user is taken to an opening page, as shown in FIG. 3, that includes several links to data entry pages. A ribbon across the top of the opening page includes links to “Idea Center”, “My Story”, and “My Last Goodbye”. Also included on the page are links to articles and an additional link to the “Idea Center.” The page likewise includes a link to add a guardian, a link to the user's bucket list, a link to the user's timeline, and a link to the user's end of life plan. The bottom of the opening page includes a table of contents for the web platform that includes links to several pages of the web platform.

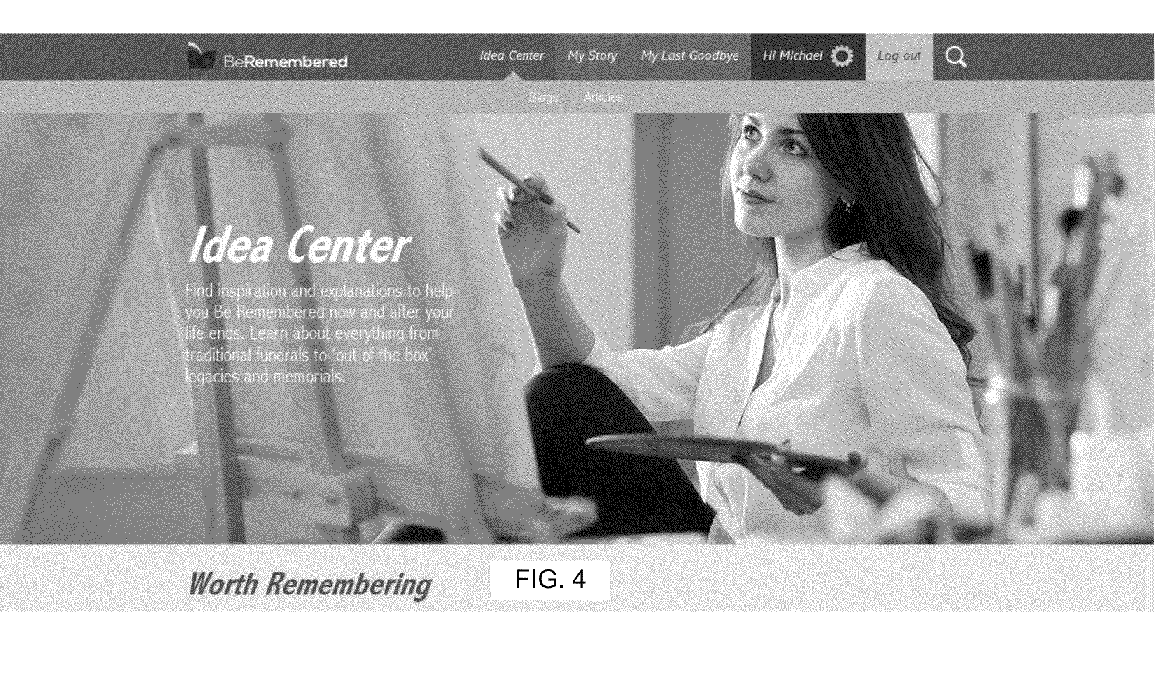

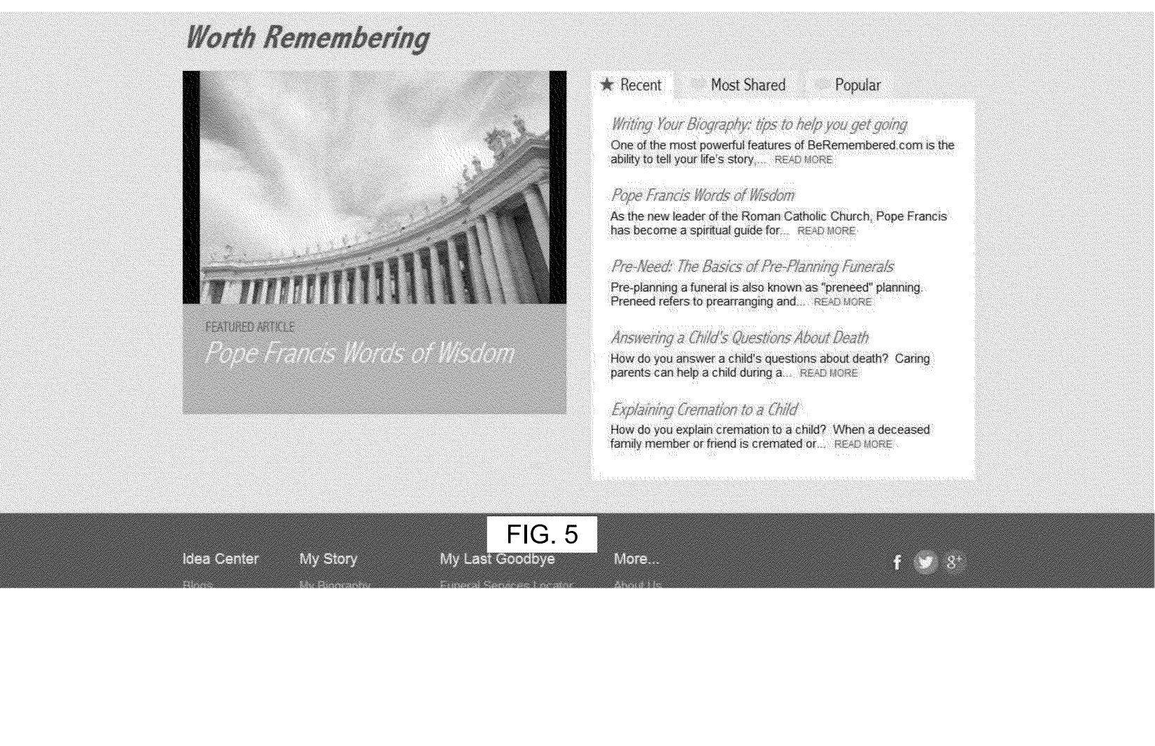

Upon selecting the “Idea Center” link, the user is taken to an idea page, as shown in FIGS. 4 and 5, that includes links to several articles and blogs discussing end of life plans. For example, the articles and blogs may include tips for preparing for end of life, tips for discussing death with children, or quotes related to life and death. The articles and blogs may be provided directly on the web platform and/or the idea page may include links to other websites that provide the article and/or blog. The user not only has the option of reviewing the articles and blogs, but the user may also share selected articles and blogs with loved ones via email or social media websites. The articles and blogs are sorted by the most recent articles/blogs, the most popular articles/blogs, and the most shared articles/blogs. The user may utilize the “Idea Center” for generating ideas for the user's own biography and end of life plan.

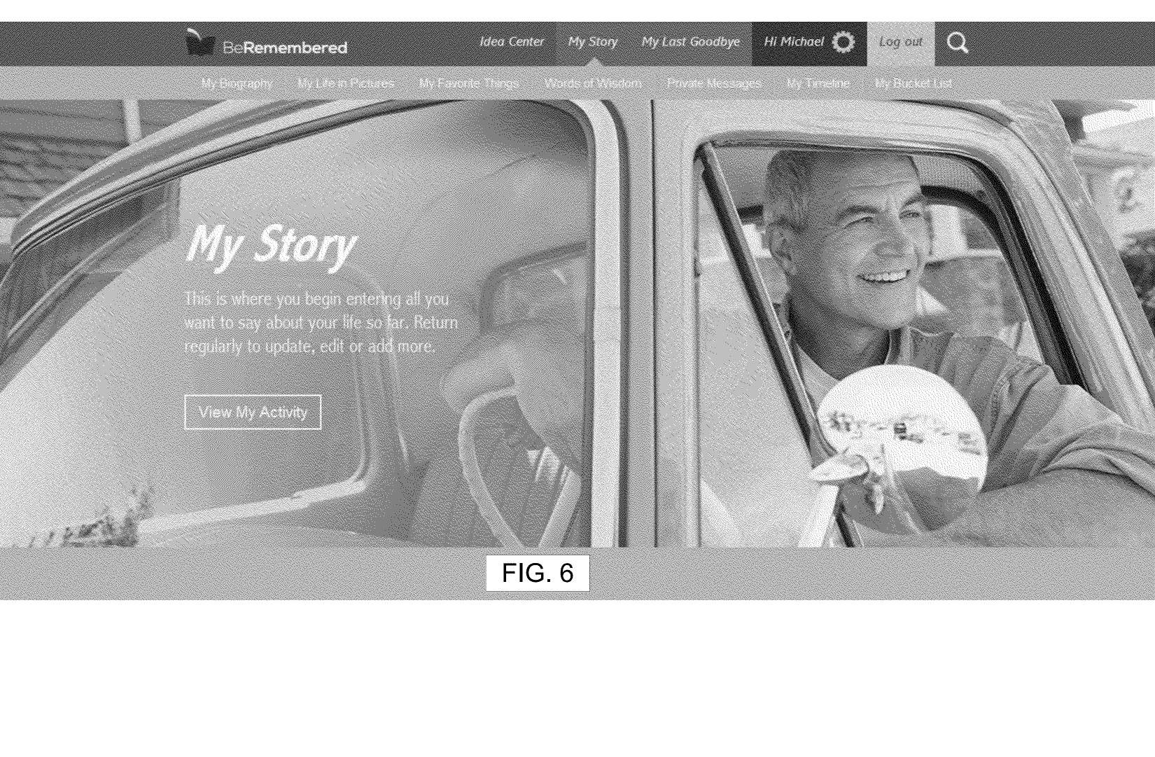

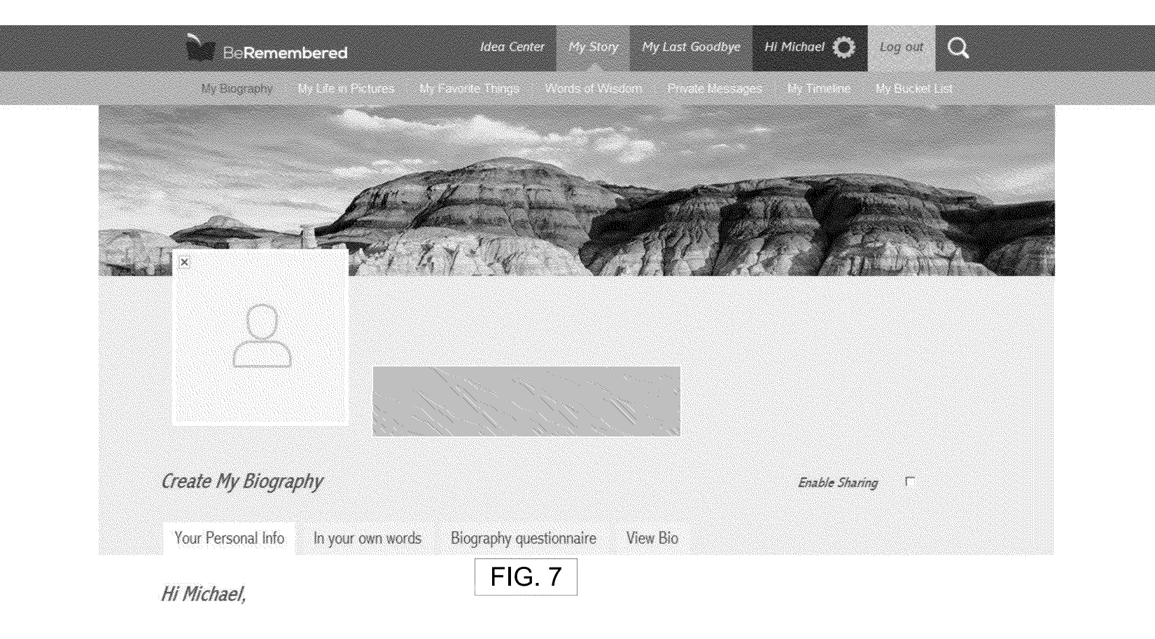

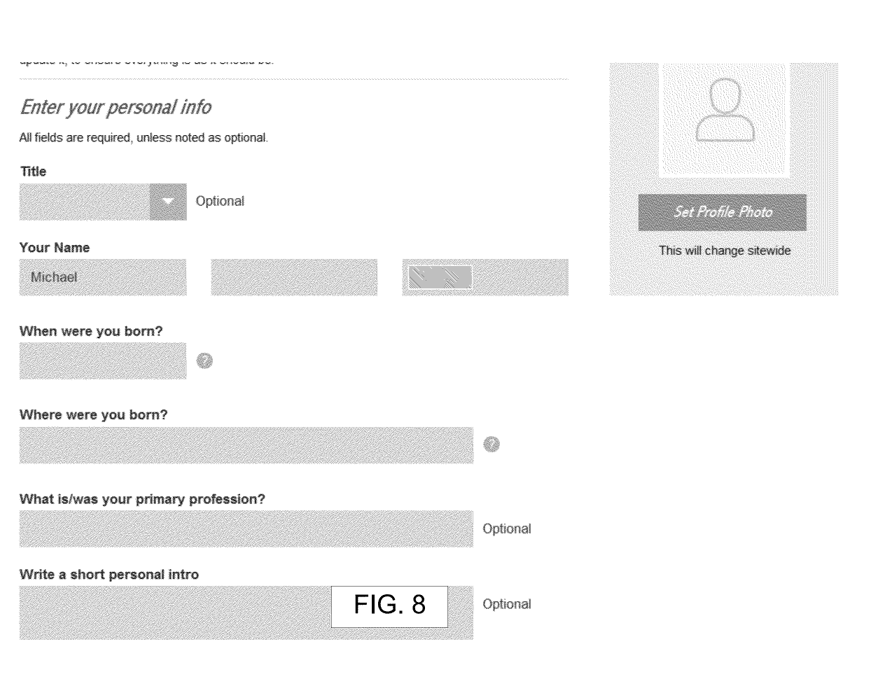

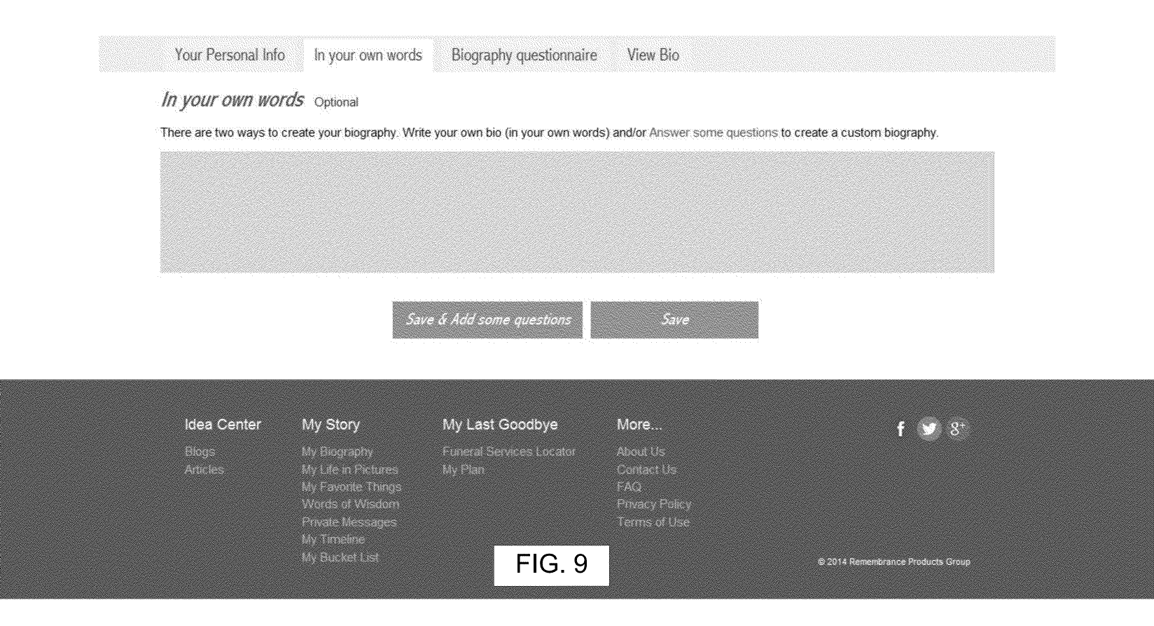

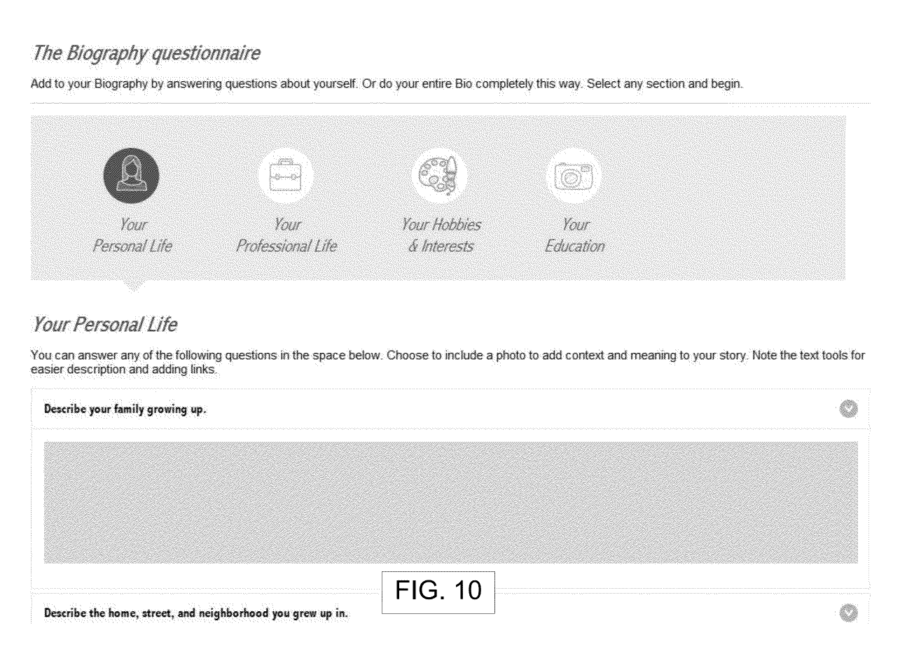

The “My Story” page, as shown in FIG. 6, provides options for the user to begin preparing their legacy for after death. The user is prompted to prepare a biography, as shown in FIG. 7, by entering basic bibliographic information such as the user's name, where and when the user was born, the user's primary profession, and a short personal introduction, as shown in FIG. 8. The user's is also provided the option of writing a free form text biography describing their life, as shown in FIG. 9. If the user finds it too difficult to write a free form biography, a questionnaire is provide to assist the user in preparing their biography, as shown in FIG. 10. The questionnaire may ask the following personal questions, “Describe your family growing up,” “Describe the home, street, and neighborhood you grew up in,” “Who were the important childhood friends in your life? Why were they important?,” “What were your favorite things to do growing up?,” Describe your adult family,” “Who are the most important people in your life today?,” and “How did you meet your spouse or significant partner?” The questionnaire also provides a list of professional questions, such as: “What has been your life's work?,” “What has brought you the most satisfaction in your career?,” “What profession did you aspire to when growing up?,” “What advice do you have for people starting in your profession today?,” and “Describe your ‘typical’ work day.” The questionnaire also provides questions related to hobbies and interest, such as: “What are your greatest interests outside of work and family?,” “What were your favorite hobbies or interests during childhood?,” “What about each hobby/interest first attracted you? What kept you interested?,” “What is your favorite moment while enjoying each of these hobbies/interests?,” and “With whom do you share these hobbies and interests?” The questionnaire may also provide questions related to education, such as: “What schools did you attend from childhood to college?,” “What do you remember most about each of these schools?,” “What were your favorite subjects in school and why?,” and “Who was your most influential teacher and why?” As will be appreciated the above questions are examples of questions that may be provided on the questionnaire. Other though provoking questions may also be provided.

After preparing a biography, the user has the option to save the biography and/or preview the content of the biography. By selecting an “Enable Sharing” button, as shown in FIG. 7, the user may share the content of the biography while the user is still alive. This content may be shared with guardians and/or loved ones by allowing access to the user's personal web page.

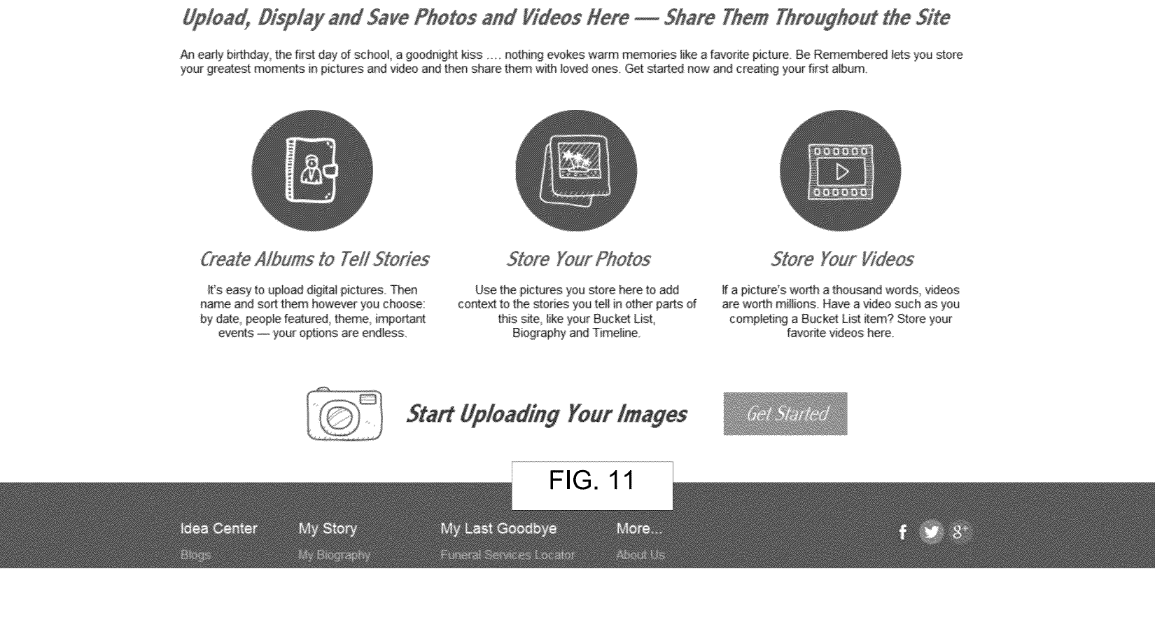

A “Life in Pictures” page allows users to upload pictures and/or videos to the user's personal web page, as shown in FIG. 11. The pictures and/or videos may be provided with captions or a longer text explanation of the video or picture. The pictures and videos may be organized into albums, such as: vacation, around the house, my grandkids, etc. Like the biography, the videos and pictures may also be shared while the user is still alive. Additionally, the videos and pictures may be linked to other portions of the personal webpage, for example, the user's biography. As an example, a video of the user's grandchildren may be linked to a portion of the user's biography discussing the grandchildren. As such, while an individual reads the user's biography, the individual may be prompted to open a photo and/or video.

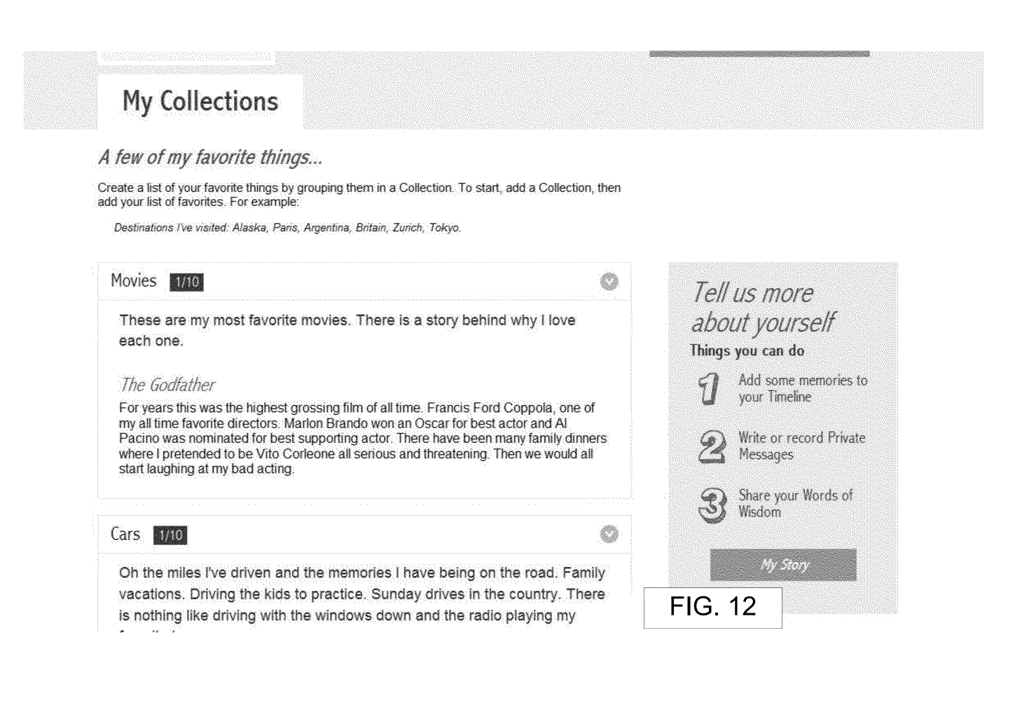

A “Favorite Things” page, as shown in FIG. 12, enables the user to provide lists and descriptions of the user's favorite things. These lists and descriptions may be categorized, for example, movies, books, TV shows, vacation destinations, etc. Additionally, the favorite things may be linked to various Internet web pages discussing the favorite things. For example, “The Twist” by Chubby Checker may be linked to a web page providing the lyrics or a sound wave of “The Twist.” The favorite things may be linked to other portions of the user's personal web page, for example, photos and videos or the biography. The list of favorite things may be updated by the user at any time. Moreover, the list of favorite things may by shared prior to the user's death.

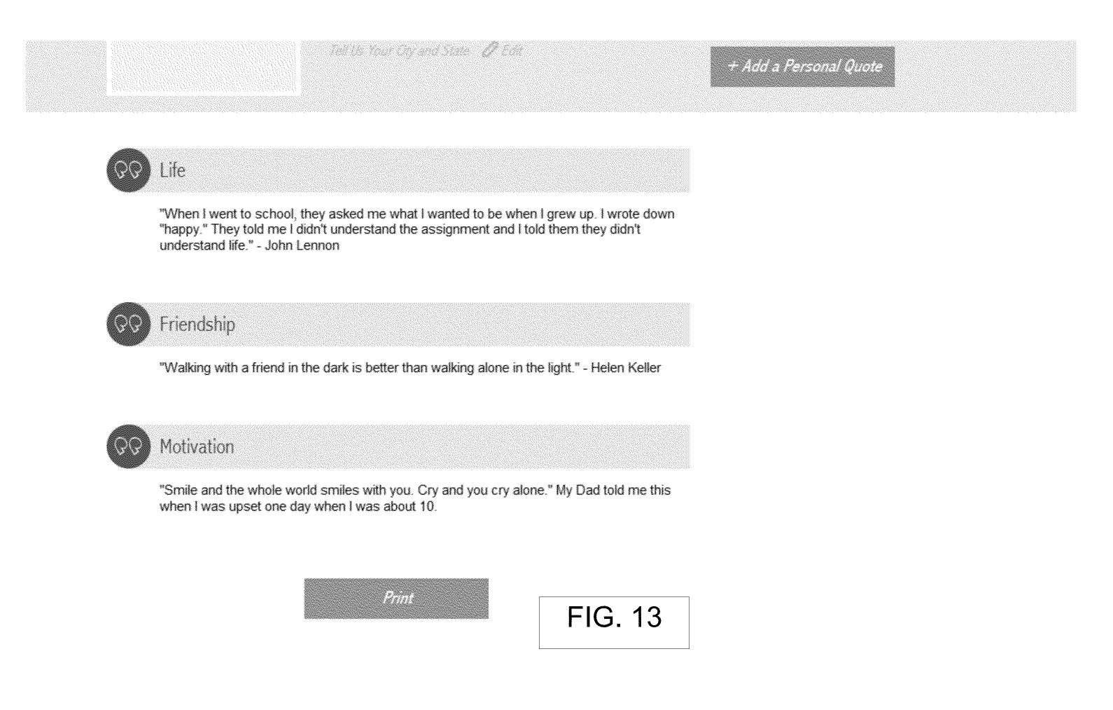

A “Words of Wisdom” page, as shown in FIG. 13, gives the user the option to add quotes to their personal webpage. The quotes may be categorized, for example, family, loving, and death. The quotes may also be linked to various portions of the personal web page and/or to other web pages on the Internet. For example, a quote by a famous person may be linked to a web page describing the famous person. The quote may be updated by the user at any time. Moreover, the quotes may by shared prior to the user's death.

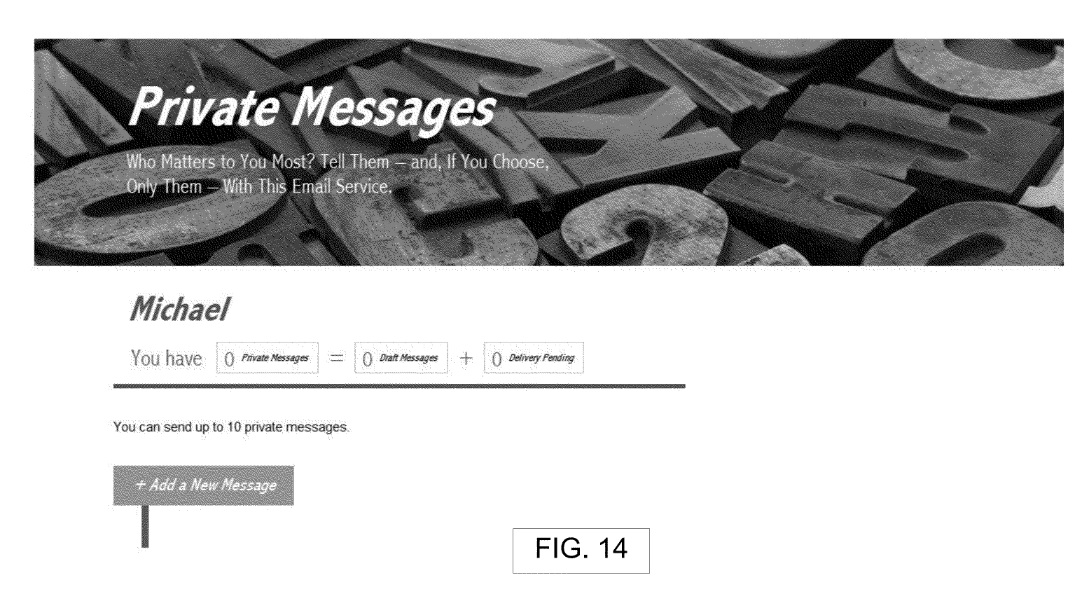

A “Private Messages” page, as shown in FIG. 14, allows the user to prepare personal messages to loved ones via email. The messages may be saved and edited at any time. After the personal message is completed it is saved within the web platform. The message may be delivered to the loved one during the user's life as a standard email. Additionally, the message may be saved and delivered to the loved one at the time of the user's death. In at least one embodiment, annual messages may be created. For example, an annual message may be created to send to a spouse every year on the spouse's birthday. The annual message may be saved until after the death of the user. For example, if the spouse's birthday is November 6 and the user passes away on Nov. 10, 2014, the birthday message will begin being delivered every year on Nov. 6, 2015.

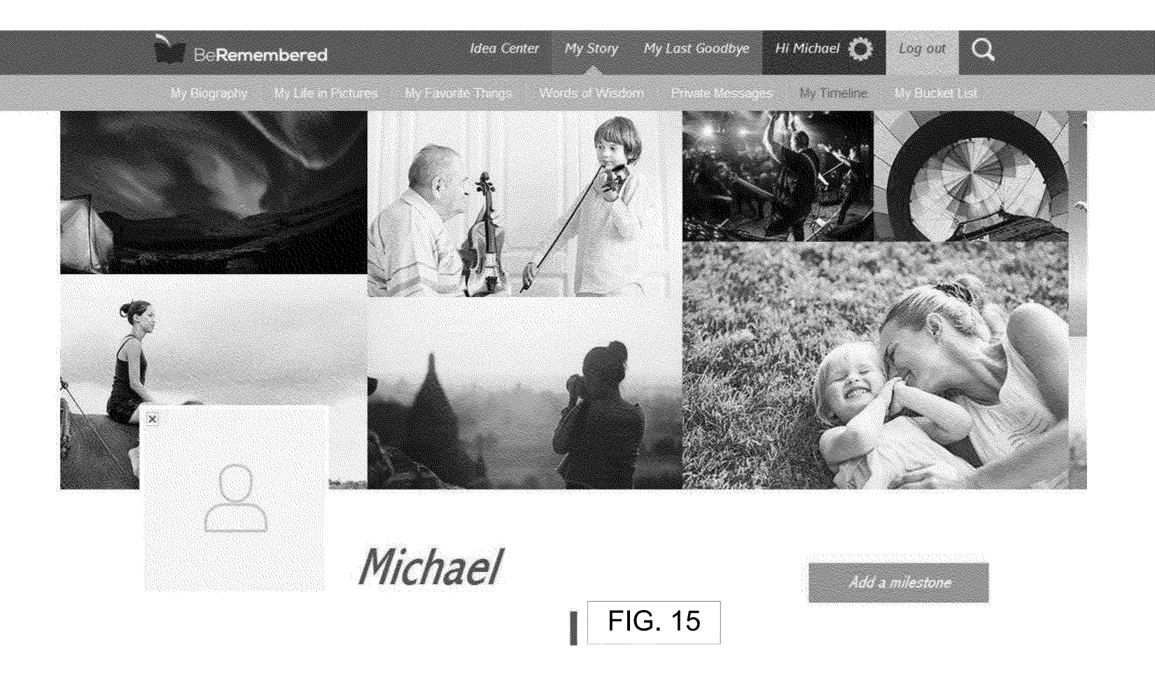

A “Timeline” page, as shown in FIG. 15, enables a user to identify milestones within their life and the lives of loved ones. In particular, the timeline may include birthdays, wedding days, graduations, days that a loved one was born, etc. The timeline may be linked to other portions of the personal web page. For example, a milestone related to a particular vacation may be linked to photos or videos of the vacation. Additionally, the timeline may be linked to other web pages, for example, a web page showing various attractions at the vacation site. The timeline may be shared with guardians and loved ones at any time or may remain private until the death of the user.

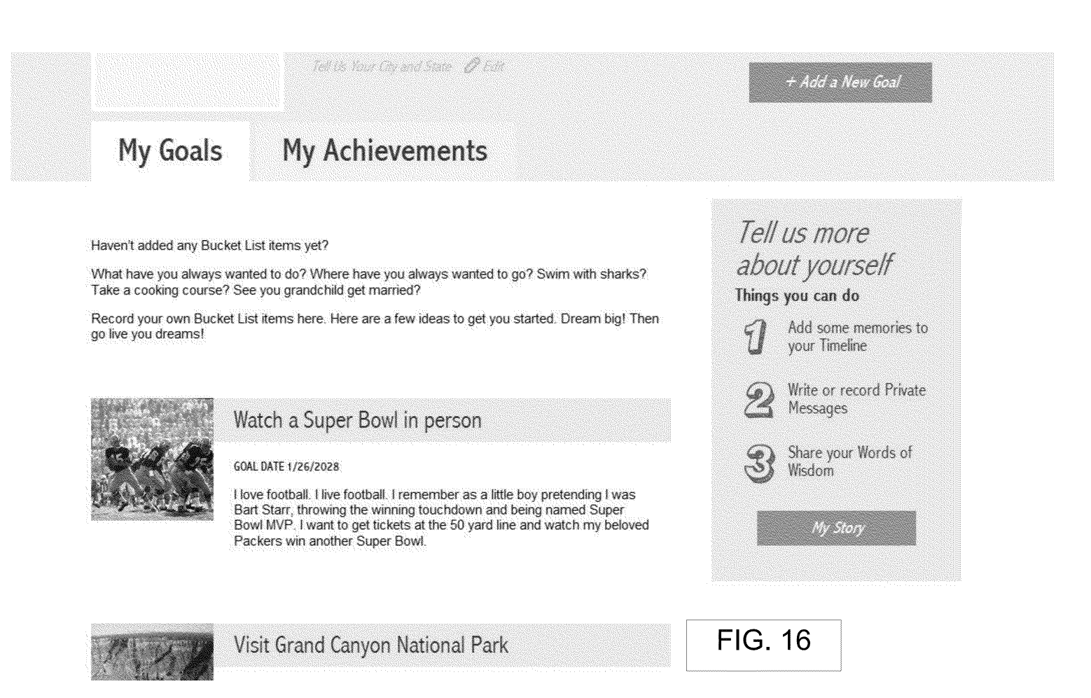

A “Bucket List” page, as shown in FIG. 16, enables the user to track specific goals for their life, for example, climb Mount Everest. The bucket list page provides suggestions for the user to add to their bucket list, but also allows the user to enter their own personal goals. The bucket list may be regularly updated as various goals are accomplished. Additionally, the user may regularly add to or delete from the bucket list. Like the other pages in the web platform, the bucket list may be liked to various portions of the personal web page. For example, an accomplished goal of climbing Mount Everest may be linked to a biography description of the climb. Moreover, the bucket list may be linked to various other web pages. The user has the option of sharing the bucket list at any time.

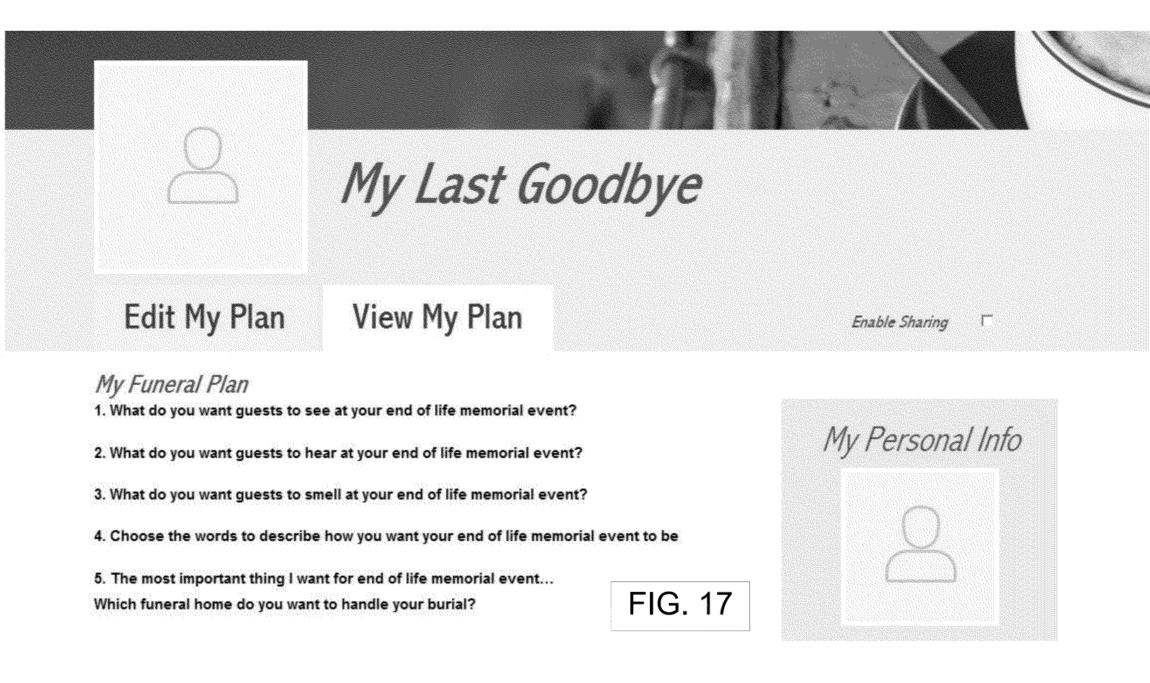

The “My Last Goodbye” page, as shown in FIG. 17, provides the user with the opportunity the prepare for funeral arrangements. A link to local funeral homes displays a map that directs the user to the closest funeral homes. The user is also able to provide insight into the type of funeral service that they would prefer to have. For example, the user may indicate songs or videos to be played at their funeral. The user may choose the type of religious service desired as well as instruct loved ones as to which church the user would prefer for their funeral. In at least one embodiment, the user may select readings for their funeral. The “My Last Goodbye” page enables the user to detail every aspect of their funeral plan.

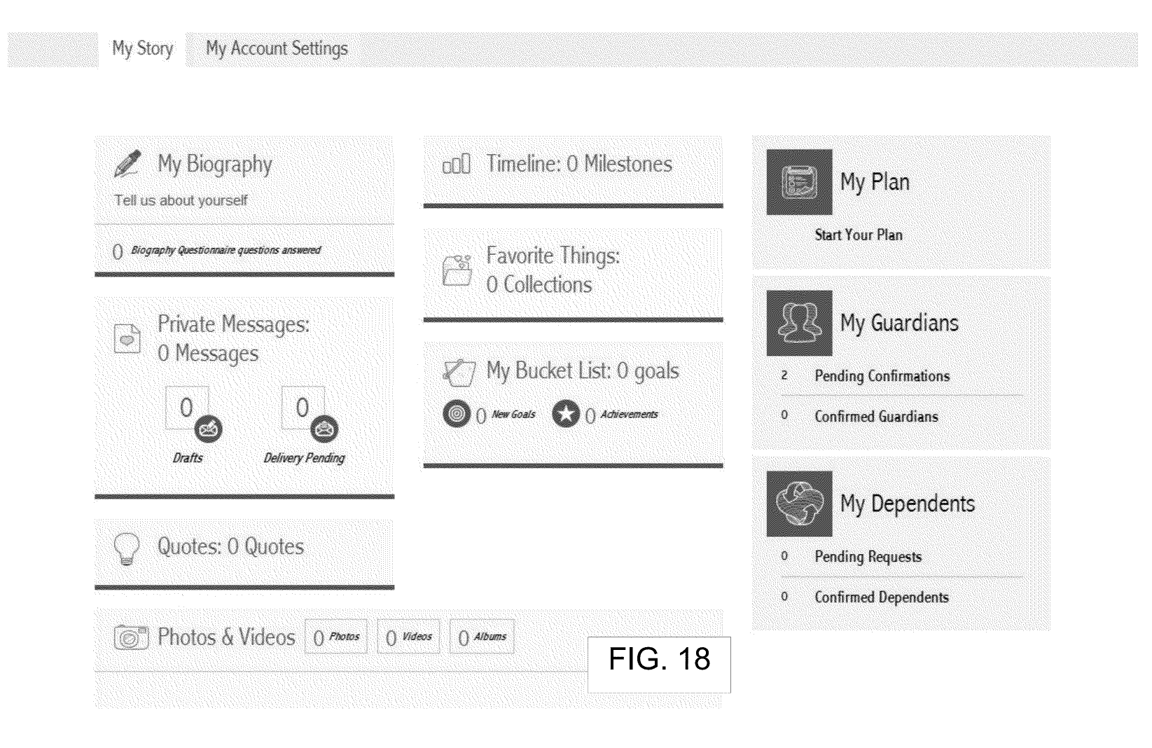

A settings page, as shown in FIG. 18 allows the user to edit any portion of their personal web site including administrative matters such as passwords and appointed guardians.

The disclosed embodiments allow the user to prepare a lasting personal website that will be available well after the user's death. The personal web site may include a biography of the user and/or mementos from the user's life, such as photos, videos, quotes, etc. as described above. The user further has the option of leaving messages for loved ones after their death. The web site is accessible and editable at any time during the user's life. Upon the death of the user, the appointed guardians may access the user's personal web page. The first appointed guardian to access the web page is given administrative control over the page. The guardian then selects an option to indicate that the user is deceased. Upon selecting this option, the user's email is sent a verification email so that a false report of death may be recognized by the user. If the user is still alive, the user notifies the web platform via return email that the notification of death was made in error. If the user is indeed deceased, the web platform turns control of the personal website over to the guardian a predetermined number of days after the verification email is delivered to the user's email account.

The web platform is built on SSL for encryption. While the user is still alive, they can choose to share individual pages with their guardian, or invite someone via email, or share a link to individual pages of their profile. When the guardian changes the user's status to “deceased” the guardian then has the ability to share pages in the same way. The user has control of who sees what, and when until the point when their guardian changes their status to “deceased.” At that point, the guardian can then review the full profile and decide who to share it with. In one embodiment, anonymous site visitors can search for users, and ask to become a “friend.”

Once the user is confirmed to be deceased, the web platform releases the contents of the personal web page to the user's loved ones. In one embodiment, the contents of the web page are released automatically by notifying the loved ones via email. In at least one embodiment, the contents of the web page are released by the guardian of the web page. Accordingly, loved ones can then log onto to the personal web page after the user's death to view the contents of the web page. In at least one other embodiment, personal messages that had been prepared by the user are automatically delivered to recipients after the user is confirmed deceased. In one embodiment, the personal messages may be delivered by the guardian of the web page.

In at least one embodiment, the web page remains private and is only accessible to those who are provided a password by the guardian. Alternatively, the web page may become public and accessible to anyone on the Internet. Accordingly, if the user's name is searched via an Internet search engine, the personal web page of the user may be provided in the search results and accessible for anyone to view.

The web page may remain active for as long as the guardian desires. Additionally, the contents of the web page may be downloaded onto a computer readable medium, such as a memory card, disc or the like. Accordingly, the contents can be copied, shared, and viewed as often as desired. If the guardian chooses to close the personal web page after a period of time, the contents or the web page are automatically downloaded to a computer readable medium and delivered to the guardian.

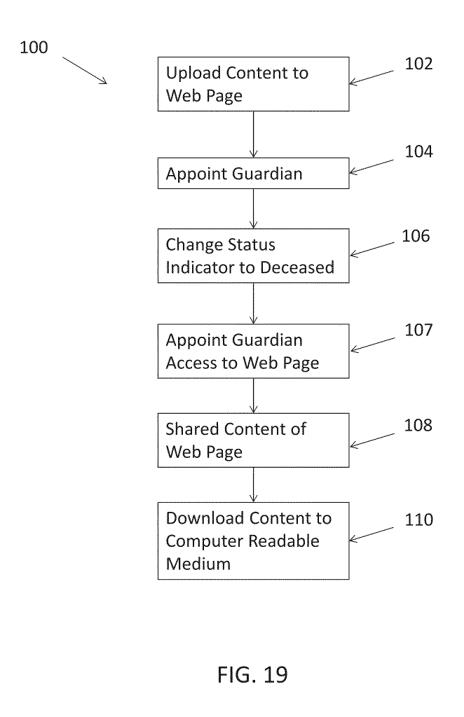

FIG. 19 illustrates a method 100 for recording a user's life in accordance with at least one embodiment. At step 102, content related to a user is uploaded to a web page. In at least one embodiment the content includes a biography, photos, videos, and a timeline of the user's life. In at least one embodiment, the content includes a funeral plan. In at least one embodiment, the content includes a bucket list. The user may be offered suggestions for the bucket list. Additionally, the bucket list may enable the user to track goals. In at least one embodiment, a questionnaire is provided for completing the biography. In at least one embodiment, the content includes private messages. In at least one embodiment, an idea page is provided to suggest ideas for content. The idea page may include blogs and articles. At step 104, a guardian is appointed over the web page. In at least one embodiment, a plurality of individuals are granted access to the guardian page. At step 106, a status indicator is selected to indicate that the user is deceased. At step 108, the guardian is appointed access to the web page after the status indicator is selected. In at least one embodiment, the guardian controls the content on the content page after the status indicator is selected. At step 110, the content of the web page is shared with selected individuals after the status indicator is selected. In at least one embodiment, the content is shared with the selected individuals by granting the selected individuals access to the content page. In at least one embodiment, the content is shared with the selected individuals by forwarding the content to the selected individuals. In at least one embodiment, private messages are delivered after the status indicator is selected. The private messages may be automatically delivered to email addresses provided by the user. Alternatively, the private messages may be delivered by the guardian. In an optional step 112, the content of the web page may be downloaded onto a computer readable medium.

In one embodiment, the website allows for affiliate branding and tracking. For example, if a funeral home or other community partner becomes a preferred partner or affiliate, the website would create a unique URL, which the partner can add to their website. If a user clicks to the presently disclosed website from that unique URL usage can be tracked, the affiliate funeral home may automatically be made the default funeral home of choice, or co-brand email communications may be provided from the referring partner.

In one embodiment, a member may invite others (not guardians) to view their profile. The status of these could be friends or family. Invited guests (not guardians) might have special permissions to see certain content. The website could also track, for the member, the number of and names of invited friends and family, and encourage members to invite more friends and family to become website members. A page may be provided where a user's family members are listed with basic information and links to their profiles, if they are members.

In one embodiment, a mobile app may be provided that allows users to add to their profile from the app.

In one embodiment, a guest user may have the ability to search for a member by name, and email that member to request access to view their profile.

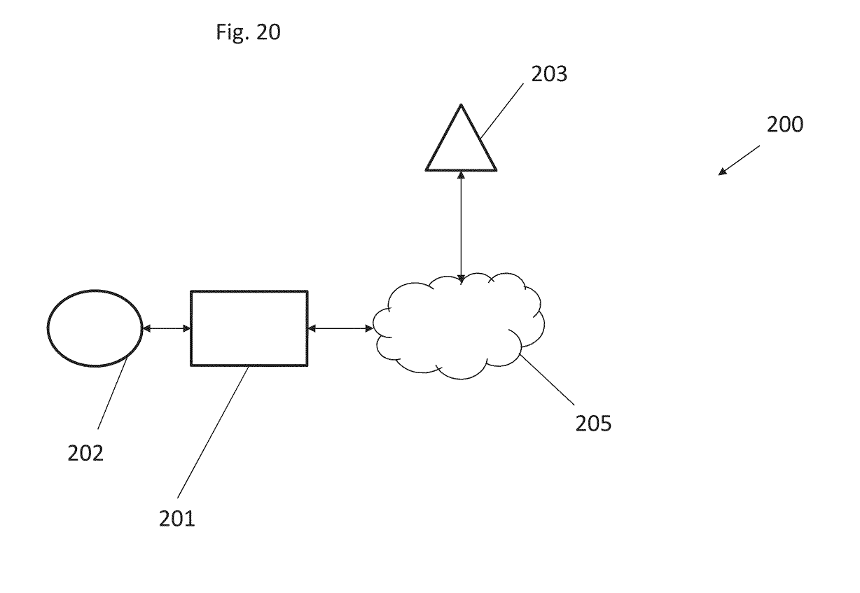

Referring now to FIG. 20, it is shown an architecture diagram detailing components of a system 200 according to at least one embodiment of the present disclosure. System 200 comprises user device 203, server 201, database 202, and computer network 205. For purposes of clarity, only one user device 203 is shown in FIG. 20. However, it is within the scope of the present disclosure that the system 200 may any number of user devices 203 at one time.

The user device 203 may be configured to transmit information to and generally interact with a web services infrastructure housed on server 201 over computer network 205. The user device 203 may include a web browser, mobile application, or other network connected software such that communication with the web services infrastructure on server 201 is possible over the computer network 205. User device 203 includes one or more computers, smartphones, tablets, wearable technology, computing devices, or systems of a type well known in the art, such as a mainframe computer, workstation, personal computer, laptop computer, hand-held computer, cellular telephone, or personal digital assistant. User device 203 comprises such software, hardware, and componentry as would occur to one of skill in the art, such as, for example, one or more microprocessors, memory systems, input/output devices, device controllers, and the like. User device 203 also comprises one or more data entry means (not shown in FIG. 20) operable by users of user device 203 for data entry, such as, for example, a pointing device (such as a mouse), keyboard, touchscreen, microphone, voice recognition, and/or other data entry means known in the art. User device 203 also comprises a display means (not shown in FIG. 20) which may comprise various types of known displays such as liquid crystal diode displays, light emitting diode display, and the like upon which information may be display in a manner perceptible to the user.

As described above, the server 201 may be configured to receive username and password, biographical information, images, content, and other information from the user device 203 to establish a profile and assorted content for someone's life. In at least one embodiment, the server 201 accesses the database 202 to store information, content and other data transmitted from the user device 203 or generated through its interaction with the server 201 in the methods and disclosed herein. The server 201 is configured to carry out one or more of the steps of methods described herein.

The user device 203 is further configured to provide input to the server 201 to carry out one or more of the steps of the methods described herein. Server 201 comprises one or more server computers, computing devices, or systems of a type known in the art. Server 201 further comprises such software, hardware, and componentry as would occur to one of skill in the art, such as, for example, microprocessors, memory systems, input/output devices, device controllers, display systems, and the like. Server 201 may comprise one of many well-known servers and/or platforms, such as, for example, IBM's AS/400 Server, RedHat Linux, IBM's AIX UNIX Server, MICROSOFT's WINDOWS NT Server, AWS Cloud services, Rackspace cloud services, any infrastructure as a service provider, or any platform as a service provider.

In FIG. 20, server 201 is shown and referred to herein as a single server. However, server 201 may comprise a plurality of servers, virtual infrastructure, or other computing devices or systems interconnected by hardware and software systems know in the art which collectively are operable to perform the functions allocated to server 201 in accordance with the present disclosure.

The database 202 is configured to store biographical data, content, and other information. Database 202 is “associated with” server 201. According to the present disclosure, database 202 can be “associated with” server 201 where, as shown in the embodiment in FIG. 20, database 202 resides on server 201. Database 202 can also be “associated with” server 201 where database 202 resides on a server or computing device remote from server 201, provided that the remote server or computing device is capable of bi-directional data transfer with server 201, such as, for example, in Amazon AWS, Rackspace, or other virtual infrastructure, or any business network. In at least one embodiment, the remote server or computing device upon which database 202 resides is electronically connected to server 201 such that the remote server or computing device is capable of continuous bi-directional data transfer with server 201.

For purposes of clarity, database 202 is shown in FIG. 20, and referred to herein as a single database. It will be appreciated by those of ordinary skill in the art that database 202 may comprise a plurality of databases connected by software systems of a type well known in the art, which collectively are operable to perform the functions delegated to database 202 according to the present disclosure. Database 202 may comprise a relational database architecture or other database architecture of a type known in the database art. Database 202 may comprise one of many well-known database management systems, such as, for example, MICROSOFT's SQL Server, MICROSOFT's ACCESS, or IBM's DB2 database management systems, or the database management systems available from ORACLE or SYBASE. Database 202 retrievably stores information that is communicated to database 202 from user device 203 or server 201.

User device 203 and server 201 communicate via computer network 205. If database 202 is in disparate infrastructure from server 201, database 202 may communicate with server 201 via computer network 205. Computer network 205 may comprise the Internet, but this is not required.

It will therefore be appreciated that the present embodiments provide an online social networking service where a user can record how they want to be remembered by their family, friends and loved ones, even after they have deceased. The user can record stories of their life, add pictures and video, describe how their end of life funeral event should be, and store private messages that are delivered to loved ones after they are deceased.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A system for recording a user's life, the system comprising:
a server; and
a database communicatively coupled to the server, the system causing the server to:
receive, over a computer network, content from a user;
store, in the database, the content and an association between the content and the user;
receive, over a computer network, an appointed guardian over the content;
receive a notification of the death of the user; and
grant the guardian administrative access to the content based at least in part on the notification.

2. The system of claim 1, wherein the server further receives a selection of one or more individuals from the user and, upon receiving the notification, grants the one or more individuals access to content through a content page.

3. The system of claim 1, wherein the server further receives a selection of one or more individuals and, upon receiving the notification, sends a communication to the one or more individuals, the communication being based at least in part on the content.

4. The system of claim 1, wherein the content includes a biography, photos, videos, and a timeline of the user's life.

5. The system of claim 1, wherein a plurality of individuals are appointed as guardians.

6. The system of claim 1, wherein the guardian controls the content through a content page transmitted from the server after the server receives the notification.

7. The system of claim 1, wherein the server displays a web-based questionnaire for completing a biography of the user and the content includes one or more answers to the web-based questionnaire.

8. The system of claim 1, wherein the content includes private messages.

9. The system of claim 8, wherein the private messages are delivered by the server after receiving the notification.

10. The system of claim 9, wherein the private messages are automatically delivered to one or more email addresses provided by the user.

11. The system of claim 9, wherein the private messages are transmitted to the guardian.

12. The system of claim 1, wherein the content includes a funeral plan.

13. The system of claim 1, wherein the content includes a bucket list.

14. The system of claim 13, wherein the server offers suggestions for the bucket list.

15. The system of claim 13, wherein the bucket list enables the user to track goals.

16. The system of claim 1, wherein the server further suggests ideas for the content.

17. The system of claim 16, wherein the suggestions include blogs and articles.

18. A method for recording a user's life, the method comprising:
uploading content related to a user to a web page;
appointing a guardian over the web page;
selecting a status indicator when the user is deceased;
granting the guardian access to the web page after the status indicator is selected; and
sharing the content of the web page with selected individuals after the status indicator is selected.

19. The method of claim 18, wherein the content is shared with the selected individuals by at least one of granting the selected individuals access to the content page or forwarding the content to the selected individuals.

20. The method of claim 18, wherein the content includes a biography, photos, videos, a timeline of the user's life, private messages, a funeral plan, and a bucket list.

21. The method of claim 20 further comprising delivering the private messages after selecting the status indicator.

22. The method of claim 20 further comprising automatically delivering the private messages to one or more email addresses provided by the user.

23. The method of claim 20 further comprising transmitting the private messages to the guardian.

24. The method of claim 20 further comprising displaying a web-based questionnaire for completing the biography.

25. The method of claim 20 further comprising offering suggestions for the bucket list.

26. The method of claim 20 further comprising enabling the user to track goals on the bucket list.

27. The method of claim 18 further comprising suggesting ideas for the content.

28. The method of claim 27, wherein the suggestions include blogs and articles.

30. The method of claim 18, wherein a plurality of individuals are appointed as guardians.

31. The method of claim 18, wherein the guardian controls the content after selecting the status indicator.
